(19) United States
(12) Patent Application Publication
(10) Pub. No.: US 2007/0284960 A1
(43) Pub. Date: Dec. 13, 2007

(54) MAGNET FOR A DYNAMOELECTRIC MACHINE, DYNAMOELECTRIC MACHINE AND METHOD

(75) Inventors: David Fulton, Anderson, IN (US); William Cai, Carmel, IN (US)

Correspondence Address: CANTOR COLBURN, LLP, 55 GRIFFIN ROAD SOUTH, BLOOMFIELD, CT, 06002, US

(73) Assignee: REMY INTERNATIONAL, INC., Anderson, IN (US)

(21) Appl. No.: 11/760,478

(22) Filed: Jun. 8, 2007

Related U.S. Application Data
(60) Provisional application No. 60/813,115, filed on Jun. 12, 2006.

(51) Int. Cl. H02K 21/12

(52) U.S. Cl. 310/156.53; 310/156.01; 310/156.38

(57) ABSTRACT

Disclosed herein is an apparatus relating to a magnet member for a dynamoelectric machine comprising, a first portion of the magnet member made of a first magnetic material and a second portion of the magnet member made of a second magnetic material. Further disclosed is a method that relates to increasing performance of an electric machine comprising, determining locations of high demagnetization fields at the dynamoelectric machine, and positioning a magnetic member having a first portion having a higher level of coercivity and a second portion having a lower level of coercivity in the machine such that the portion having a higher level of coercivity is more proximate the location of high demagnetization fields than the portion having the lower level of coercivity.

### CROSS REFERENCE TO RELATED APPLICATION

The present application claims priority to U.S. Provisional Patent Application Ser. No. 60/813,115, filed Jun. 12, 2006, the entire contents of which are specifically incorporated herein by reference.

### BACKGROUND OF THE INVENTION

Dyanmoelectric machines often use permanent magnets in conversion of mechanical energy to electrical energy and vice versa. Several parameters regarding the permanent magnets are specified to optimize the performance of the machine such as: shape, size, material and positional locations within the dynamoelectric machine.

The material from which a permanent magnet is fabricated is a primary factor in determining flux density. The performance of a permanent magnet is evaluated in engineering applications by using its maximum energy product, which is the product of flux density (B) and magnetic field strength (H), that is, (BH)ₘₐₓ. Generally, a permanent magnet with a higher (BH)ₘₐₓ improves the performance of a dynamoelectric machine. For a given (BH)ₘₐₓ, however, magnet materials with high remanence (Br) typically are more susceptible to unrecoverable demagnetization than magnet materials with a low remanence. This is because higher remanence causes a lower coercive force (Hc). Unrecoverable demagnetization occurs when an operation point defined by a flux density (B) and a magnetic field strength (H) in the magnetized direction is below the knee point on the demagnetization curve of the permanent magnet.

Demagnetization occurs when a permanent magnet experiences a magnetic field in a direction that is opposite to that in which the magnet is initially magnetized. Because in a dynamoelectric machine there are electromagnetic fields generated during operation of the machine, and which in some instances subject permanent magnets to reverse polarity fields, unrecoverable demagnetization can be problematic for machine longevity. Coercivity, also known by the symbol H_{c}, is a measure of the reverse field needed to drive the magnetization of the magnet to zero. The coercivity of a magnet is primarily a function of the material from which the magnet is produced. In general, the properties of coercivity and remanence are inversely proportional to one another such that an increase in remanence is accompanied by a drop in coercivity for a permanent magnet with a given (BH)ₘₐₓ. While it is possible to obtain both high remanence and coercivity, the materials required to do so are more expensive than materials that have a moderate to low value of either coercivity or remanence. Designers of dynamoelectric machines must therefore balance coercivity, remanence and cost when specifying permanent magnets for a machine.

Improvements in the art that reduce the effects of the compromise are ubiquitously well received.

### BRIEF DESCRIPTION OF THE INVENTION

Disclosed herein is an apparatus that relates to a magnet member for a dynamoelectric machine comprising, a first portion of the magnet member made of a first magnetic material and a second portion of the magnet member made of a second magnetic material. Further disclosed herein is an apparatus that relates to a dynamoelectric machine member with at least one magnet member wherein, the at least one magnet member comprises a plurality of magnetic materials having different values of coercivity from one another.

Further disclosed is a method that relates to increasing performance of an electric machine comprising, determining locations of high demagnetization fields at the dynamoelectric machine, and positioning a magnetic member having a first portion having a higher level of coercivity and a second portion having a lower level of coercivity in the machine such that the portion having a higher level of coercivity is more proximate the location of high demagnetization fields than the portion having the lower level of coercivity.

Further disclosed herein is a method that relates to tailoring flux distribution in a dynamoelectric machine comprising, creating a magnet member having a first portion having a first level of coercivity and a second portion having a second level of coercivity, and positioning the magnetic member to achieve a desired flux distribution.

### BRIEF DESCRIPTION OF THE DRAWINGS

The following descriptions should not be considered limiting in any way. With reference to the accompanying drawings, like elements are numbered alike:

FIG. 1 depicts a partial cross sectional view of a rotor disclosed herein;

FIG. 2 depicts a partial cross sectional view of another rotor disclosed herein;

FIG. 3 depicts a partial cross sectional view of another rotor disclosed herein;

FIG. 4 depicts a cross sectional view of a direct current motor disclosed herein;

FIG. 5 depicts a cross sectional view of another rotor disclosed herein; and

FIG. 6 depicts a partial cross sectional view of another rotor disclosed herein.

### DETAILED DESCRIPTION OF THE INVENTION

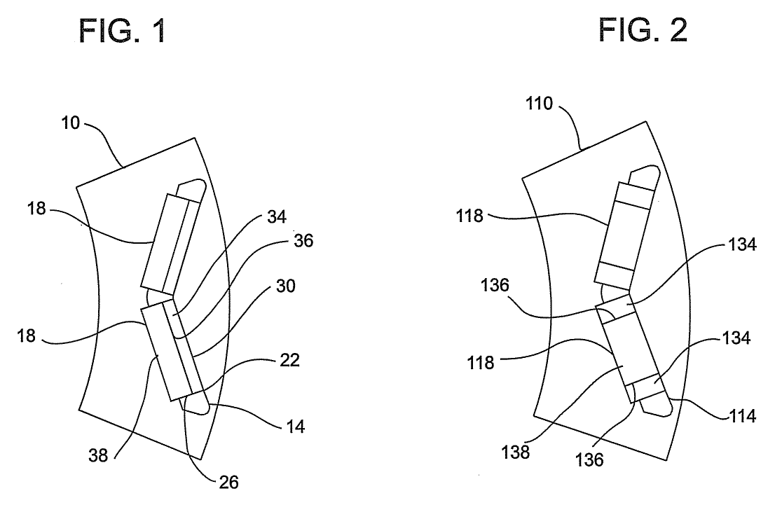

Referring to FIG. 1 a dynamoelectric machine member 10, of an internal permanent magnet machine, depicted in this exemplary embodiment as a rotor, has a cavity 14 formed therein for locating and positioning magnet members 18. The cavity 14, in one embodiment, is sized to provide a press-fit with the magnet members 18 thereby preventing relative movement between the rotor 10 and the magnet members 18. It is to be appreciated that while machine member 10 and other similar members are illustrated herein as rotors, they may equally exist as stators, motor casings, etc. without departing from the scope of the invention.

As described above, the magnetic properties of remanence and coercivity are important to the overall performance of the machine. Other factors affecting performance are the shape of magnet members 18 and the position of the magnet members 18 within the machine. In addition to performance, the shape and position of the magnet members 18 also affects their susceptibility to magnetic fields that may be in an opposite direction to the permanent magnetic field of the magnetic members 18. Such an oppositely directed field, sometimes referred to as a reverse magnetic field, and as noted above, will have an effect of demagnetizing the magnetic members 18 if the reverse magnetic field is of adequate strength. The demagnetizing effect, however, is stronger on certain areas of the members 18 than on other areas. The corners 22, ends 26 and surfaces 30 of the magnet members 18 are often more susceptible to demagnetization fields than other portions of the magnet members 18. Consequently, some demagnetization sometimes occurs in these areas resulting in a lower overall remanence of the magnet members 18. Such a drop in the remanence of the magnet member 18, as discussed above, results in a drop in the overall performance of the dynamoelectric machine.

An embodiment of the present invention depicted in FIG. 1 shows the magnet members 18 divided into two portions. A first portion 34 extends from the surface 30 of the magnet member 18 through a partial thickness of the magnet member 18 to a depth delineated herein by borderline 36. A second portion 38 comprises the balance of the magnet member 18 that is not part of the first portion 34. The first portion 34 may be fabricated from a first magnetic material that has a higher coercivity than a material used to fabricate the second portion 38. Similarly, the second portion 38 may be constructed from a magnetic material that has a higher remanence than the material used to fabricate the first portion 34. Such a construction of a magnet member 18 permits the magnet member 18 to have a higher resistance to demagnetization at the first portion 34 than at the second portion 38. Similarly, the construction permits the second portion 38 to have a higher magnetic flux density resulting from the higher remanence level thereof. Tailoring portions of magnet members for a variety of dynamoelectric machines may be performed, in a manner similar to the foregoing description, to optimize the coercivity of magnet members while maintaining high levels of remanence at economical cost levels.

Referring to FIG. 2 and alternate embodiment of magnet members within a rotor are shown. Magnet members 118 are positioned within a cavity 114 of the dynamoelectric machine member 110 shown herein as a rotor. The magnet members 118 are divided into first portions 134 and second portions 138 separated by borderlines 136. The first portions 134 may be constructed of magnetic material with a higher coercivity than the material of the second portions 138, while the second portions 138 may be constructed of magnetic material with a higher remanence than the material of the first portions 134. Consequently, magnet members 118 have a higher resistance to demagnetization of the first portions 134 than of the second portions 138. Though the magnet members 18, 118 shown thus far have been rectangular in shape the concept of multiple portions of magnet members made from various magnet materials is applicable to other shapes as well.

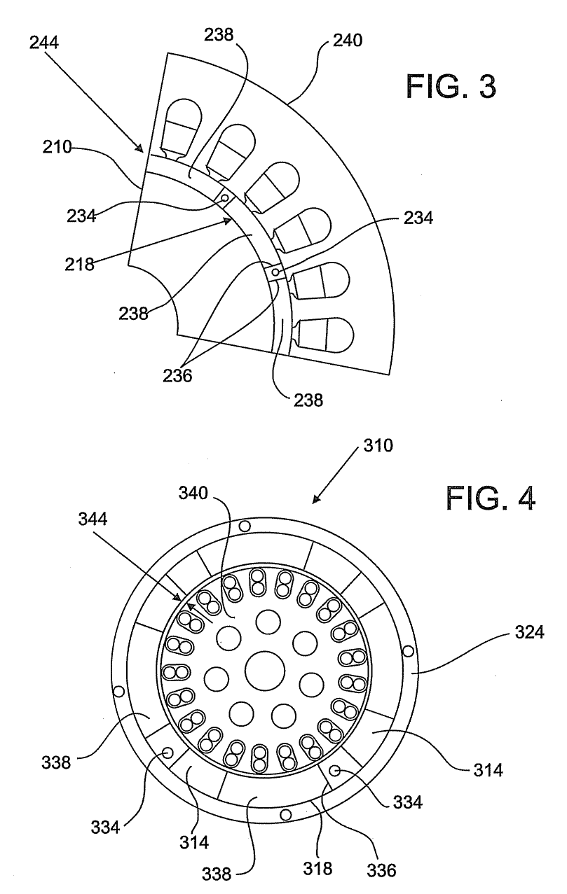

Referring to FIG. 3 a magnet member 218, of a surface-mounted permanent magnet machine, with an arcuate shape is depicted. The magnet member 218 forms a circumferential portion of a dynamoelectric machine member 210 shown here as a rotor, which is surrounded by a stator 240 with an air-gap 244 therebetween. The magnet members 218 are divided into first portions 234 and second portions 238 separated by borderlines 236. The first portions 234 may be constructed of magnetic material with a higher coercivity than the material of the second portions 238, while the second portions 238 may be constructed of magnetic material with a higher remanence than the material of the first portions 234. Consequently, the magnet members 218 have a higher resistance to demagnetization of the first portions 234 than of the second portions 238.

Referring to FIG. 4 another embodiment of the invention depicts a dynamoelectric machine 310 that is a direct current (DC) motor. A dynamoelectric machine member 324, shown here as a motor casing, surrounds four arc shaped magnet members 318. An armature 340 is located concentrically within the magnet members 318 with a radial air-gap 344 formed therebetween. The magnet members 318 are divided into first portions 334 and second portions 338 separated by borderlines 336. The first portions 334 may be constructed of magnetic material with a higher coercivity than the material of the second portions 338, while the second portions 338 may be constructed of magnetic material with a higher remanence than the material of the first portions 334. Consequently, the magnet members 318 have a higher resistance to demagnetization of the first portions 334 than of the second portions 338.

The magnet members 18, 118, 218, 318 of FIGS. 1-4 have the first portions 34, 134, 234, 334 separated from the second portions 38, 138, 238, 338 by borderlines 36, 136, 236, 336. The construction of the first portions 34, 134, 234, 334 and the second portions 38, 138, 238, 338 determines the form that the borderlines 36, 136, 236, 336 take. For example, if the first portions 34, 134, 234, 334 and the second portions 38, 138, 238, 338 are formed as independent permanent magnet segments, then the borderlines 36, 136, 236, 336 may simply be the butting together of surfaces of the two contacting portions held in contact by forces normal to the surfaces. Such normal forces may be created by, for example, the dynamoelectric machine member 10, 110, 210, 324 to which the magnet members 18, 118, 218, 318 are attached. Alternately, the portions may be held together by adhesive at the borderlines 36, 136, 236, 336.

Alternately, the first portions 34, 134, 234, 334 and the second portions 38, 138, 238, 338 maybe integrally formed as the magnet members 18, 118, 218, 318 are fabricated. For example, if the magnet members 18, 118, 218, 318 are fabricated from powdered materials compressed to shape and sintered, the different magnetic materials used for the first portions 34, 134, 234, 334 and the second portions 38, 138, 238, 338 may be placed into the press prior to pressing to shape. Such a fabrication method will create borderlines 36, 136, 236, 336 that are less distinct than those where the two portions are fabricated as separate segments. This technique can be used to fabricate magnet members 18 with two or more grades of magnetic material within a single magnet member 18. In so doing, the designer of the dynamoelectric machine can custom design magnet members 18 by positioning magnetic materials with specific magnetic properties in different areas of a magnet member 18. For example, the corners 22 may have a higher percentage of material with a high coercivity level than the balance of the magnet member 18, which may use a material with a higher percentage of material with a high remanence level. Both of the magnetic materials used may have lower per volume costs than a single magnet material that had both a high coercivity level and high remanence level, thereby lowering the overall material cost of the magnet member 18.

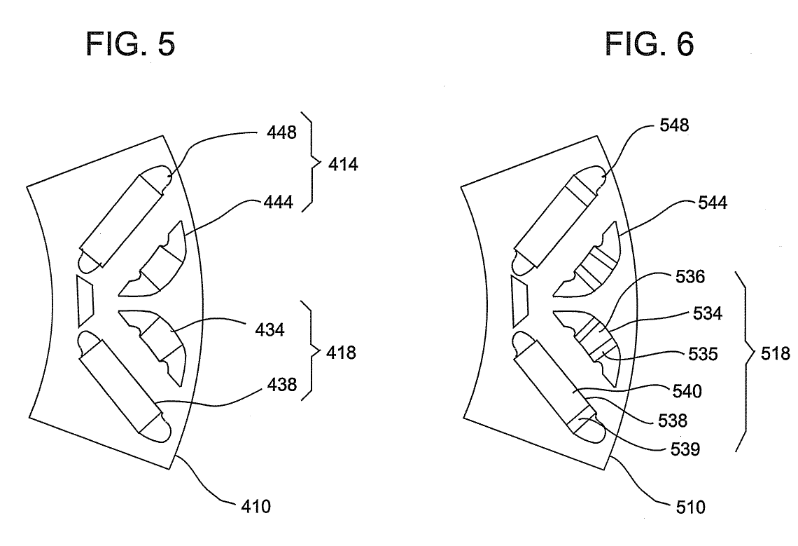

Referring to FIG. 5 in yet another embodiment magnet members 418 comprise a plurality of portions, such as first portions 434 and second portions 438 that are proximate each other while not actually being in contact with each other. Such portions 434, 438 are located in cavities 444, 448 respectively, of a dynamoelectric machine member 410 shown here as a rotor. The first portions 434 may be constructed of magnetic material with a higher coercivity than the material of the second portions 438, while the second portions 438 may be constructed of magnetic material with a higher remanence than the material of the first portions 434. Consequently, the magnet members 418 have a higher resistance to demagnetization of the first portions 434 than of the second portions 438.

Referring to FIG. 6 an alternate embodiment with magnet members 518 comprise a plurality of portions, such as first portions 534 and second portions 538 that are proximate each other while not actually being in contact with one another. Such portions 534, 538 are located in cavities 544, 548 respectively, of a dynamoelectric machine member 510 shown here as a rotor. The first portions 534 further comprises first sub-portions 535 and second sub-portions 536, and the second portions 538 further comprises third sub-portion 539 and fourth sub-portion 540. The first sub-portions 535 are constructed of magnetic material with a higher coercivity than the material of second sub-portions 536, which are constructed of magnetic material with a higher coercivity than the material of third sub-portions 539, which are constructed of magnetic material with a higher coercivity than the material of fourth sub-portions 540. Consequently, the magnet members 518 have a higher resistance to demagnetization of the first sub-portions 535 than of the second sub-portions 536 than of the third sub-portions 539 than of the fourth sub-portions 540. It should be noted that the number of sub-portions is not limited to four as depicted in this embodiment but may be any practical number of sub-portions. Additionally, the relationship of coercivity value between any two of the sub-portions may be set as appropriate to the particular application.

Constructing magnet members 18 with multiple materials provides greater design flexibility in other ways as well. For example, the waveform of the flux density in the air-gap of a dynamoelectric machine may be shaped to reduce torque ripple and core losses. For two layer sinusoidal internal permanent magnet machines the resulting high residual flux density at a bottom layer can make the air-gap flux density more sinusoidal and thereby reduce the harmonic components of the air-gap flux density. Further, portioning the magnet members into different grades of magnetic material may help reduce the eddy current losses inside the magnet members, thereby improving low temperature performance of the dynamoelectric machine. Further still, portioning the magnet members allows a dynamoelectric machine with one set of components, with fixed sizes, to have differing levels of performance, thereby avoiding costs that would be expended to fabricate tools for components of various sizes to build dynamoelectric machines with different performance levels. The grades of permanent magnets may be more than two grades, such as three or more.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A magnet member for a dynamoelectric machine, comprising:
a first portion of the magnet member made of a first magnetic material and a second portion of the magnet member made of a second magnetic material.

2. The magnet member of claim 1, wherein:
one of the first portion or the second portion has a higher coercivity than the other of the first portion or the second portion, and the one of the first portion or the second portion that has the higher coercivity has a lower remanence than the other of the first portion or the second portion.

3. The magnet member of claim 1, wherein:
the first portion is a first magnet and the second portion is a second magnet and the first and second magnets approximate each other.

4. The magnet member of claim 1, wherein:
the first portion having a relatively high percentage of a first magnetic material and the second portion having a relatively high percentage of a second magnetic material, the first and second portions being integrally formed.

5. A dynamoelectric machine member with at least one magnet member, wherein:
the at least one magnet member comprises a plurality of magnetic materials having different values of coercivity from one another.

6. The dynamoelectric machine member of claim 5, wherein:
the plurality of magnetic materials have different values of remanence from one another.

7. The dynamoelectric machine member of claim 5, wherein:
the dynamoelectric machine member is a rotor.

8. The dynamoelectric machine member of claim 5, wherein:
the dynamoelectric machine member is a stator.

9. The dynamoelectric machine member of claim 5, wherein:
the dynamoelectric machine member is a motor casing.

10. A method of increasing performance of a dynamoelectric machine, comprising:
selecting permanent magnetic materials with both a high level of coercivity and a low level of coercivity;
constructing permanent magnets from the selected magnetic materials; and
positioning the high coercivity permanent magnetic material in areas of the dynamoelectric machine that exhibits a higher demagnetization field.

11. A method of increasing performance of a dynamoelectric machine, comprising:
determining locations of high demagnetization fields at the dynamoelectric machine; and
positioning a magnetic member having a first portion having a higher level of coercivity and a second portion having a lower level of coercivity in the machine such that the portion having a higher level of coercivity is more proximate the location of high demagnetization fields than the portion having the lower level of coercivity.

12. A method of tailoring flux distribution in a dynamoelectric machine, comprising:
creating a magnet member having a first portion having a first level of coercivity and a second portion having a second level of coercivity; and
positioning the magnetic member to achieve a desired flux distribution.
